(19) United States
(12) Patent Application Publication
(10) Pub. No.: US 2002/0056088 A1
(43) Pub. Date: May 9, 2002

(54) Contextual programming

(76) Inventors: Carlos A. Silva JR., Potomac, MD (US); Laurence F. Kirsh, Herndon, VA (US); Robert M. Cooper, Arlington, VA (US); George D. Escobar, Purcellville, VA (US); William Houghton, Vienna, VA (US)

Correspondence Address: ROBERT V. RACUNAS, Fish & Richardson P.C., 601 Thirteenth Street, NW, Washington, DC, 20005, US

(21) Appl. No.: 09/828,469

(22) Filed: Apr. 9, 2001

Related U.S. Application Data
(60) Provisional application No. 60/195,248, filed on Apr. 7, 2000.

(51) Int. Cl. H04N 7/16

(52) U.S. Cl. 725/9

(57) ABSTRACT

Systems and techniques for providing content relevant to television programming currently displayed to a viewer by determining television programming being viewed by a viewer at a particular time; determining context information associated with the television programming available for delivery to the viewer; making an intelligent selection from the available context information; and delivering the selected context information to the viewer.

This application claims priority from application Ser. No. 09/365,734, filed Aug. 3, 1999, application Ser. No. 09/365,735, filed Aug. 3, 1999, and application Ser. No. 09/475,391, filed Dec. 30, 1999. This application also claims the benefit of Provisional Application No. 60/195,248, filed Apr. 7, 2000. These applications are incorporated by reference in their entirety.

### TECHNICAL FIELD

This application relates generally to a communications system and more particularly to a communications system for providing content relevant to television programming.

### BACKGROUND

Web-based TV (television) systems make dual usage of conventional television sets. That is, a user of a web-based TV system can either view television programming or access the Internet through the television set. A web-based system typically includes a device known as a set-top box, which connects to the television and translates Internet content into a TV signal.

In general, accessing the Internet through a television set may have significant drawbacks when compared to accessing the Internet using a PC (personal computer). When set-top boxes are not equipped to function as computers, the capabilities of a web-based TV system can be quite limited. For example, while a user typically can surf to most Web sites and send e-mail, the user may not be able to display certain content, download files, or store information.

### SUMMARY

In one general aspect, content relevant to television programming displayed to a viewer is provided by determining television programming being viewed by a viewer at a particular time, determining context information associated with the television programming available for delivery to the viewer, making an intelligent selection from the available context information, and delivering the selected context information to the viewer.

Implementations may include one or more of the following features. For example, determining the television programming being viewed by a viewer at a particular time may be based on television programming tuned to by a set-top box or based on an electronic programming guide (“EPG”). The television programming may be a television program name or episode, a broadcaster identifier, a network identifier, a channel identification number, an EPG identifier, a program content category, or an EPG content category. The context information associated with the television programming may be determined based upon a television signal received by a set-top box, a channel identification number, a broadcaster identifier, a network identifier, a television program name or episode, an EPG identifier, a program content category, or an EPG content category. The context information may include a uniform resource locator (“URL”), such as a shopping website, a new website, a viewer polling website, an advertising website, a webpage registered with an online service provider (“OSP”), an OSP partner-programmed web page. The context information also may include advertising, an online chat room, an instant messaging buddy list, news, a merchandise purchasing opportunity, and/or a viewer poll.

An intelligent selection may be made from among the available context information based upon a predetermined hierarchy, a viewer determined hierarchy, or a dynamically determined hierarchy. For example, the hierarchy may be determined by an episode or name of a television program, a broadcaster identifier, a network identifier, a content category, an EPG category, and/or an EPG identifier. In one implementation, the context information is first selected based upon an episode of a television program. If no context information based upon the episode is found, the context information is selected based upon a name of the television program. If no context information based upon the name of the television program is found, the context information is selected based upon a broadcaster identifier. If no context information based upon a broadcaster identifier is found, the context information is selected based upon a content category.

The selected context information may be delivered to the viewer by a set-top box displaying the information on the viewer's monitor or television screen. Typically, the selected context information is displayed along with the television programming. A television signal containing the television programming may be received, and the television signal may contain the context information. The context information may be received during the vertical blanking interval of the television signal.

The context information may be determined while the viewer is offline or online. The context information accessed by the viewer may be tracked and reported.

In another general aspect, a system that provides content relevant to television programming may have a set-top box with communications links for receiving context information, a television signal containing television programming, or both. A monitor displays the received television programming and context information. Software instructions stored within the set-top box provide content relevant to the television programming and cause the context information to be displayed along with the television programming. Implementations may include a television signal that contains the television programming and the context information. The context information may be received during the vertical blanking interval of the television signal.

In another general aspect, a graphical user interface provides content relevant to television programming through an area designated for display of television programming and an area designated for display of context information associated with the television programming.

These and other aspects may be implemented by an apparatus and/or a computer program stored on a computer readable medium. The computer readable medium may be a disc, a client device, a host device, and/or a propagated signal.

Other features and advantages will be apparent from the following description, including the drawings, and the claims.

### DESCRIPTION OF DRAWINGS

FIG. 1 is a block diagram of a web-based TV system.

FIG. 2 is a block diagram of a set-top box system.

FIGS. 3 and 4 are flow charts of communications methods that may be implemented by the systems of FIG. 1 and FIG. 2.

FIGS. 5-8 are screen shots that may be used to deliver contextual information and television programming to viewers.

Like reference symbols in the various drawings indicate like elements.

### DETAILED DESCRIPTION

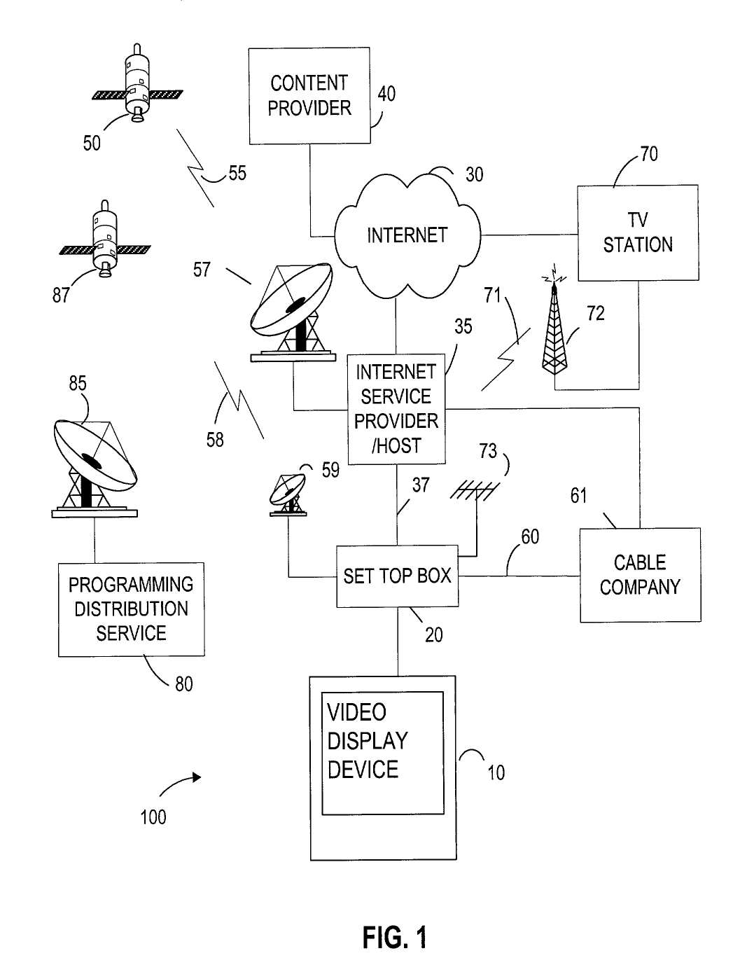

An exemplary web-based TV system 100 is shown in FIG. 1. The system 100 includes a set-top box 20 connected to a video display device 10. The video display device 10 may be implemented using, for example, an analog TV, a digital TV, a high definition TV (HDTV), a video monitor, or another device capable of displaying analog and/or digital video signals. The set-top box 20 gathers and manages content for presentation on the video display device 10.

The set-top box 20 gathers and manages two primary types of content: web content and TV content. Web content includes, for example, digital information that is typically, but not exclusively, communicated over a communications network. Examples of web content include: a web page, an image file, an audio file, a video file, a data file, a program, an e-mail message, an instant message, and a chat session. TV content may include digital and analog information intended for presentation on a video display device that generally corresponds to established standards, such as, for example, European Telecommunications Standards Institute (ETSI), Digital Video Broadcasting (DVB), Advanced Television Systems Committee (ATSC), or European Cable Communications Association (ECCA). Examples of TV content include a broadcast TV program, a satellite TV program, a cable TV program, an output of a video player/recorder device, such as, for example, a videocassette recorder (VCR), a laser disc player, and a digital videodisk (DVD) player, and output of a video camera.

The set-top box 20 may use any of a variety of known methods to gather web and TV content. The set-top box 20 can be configured to receive web content from sources, such as an ultra high frequency (UHF) or a very high frequency (VHF) transmitter, a digital transmitter, a radio frequency (RF) transmitter, a satellite transmitter, a cable TV provider, and the Internet. For example, the set-top box 20 can access web content over the Internet 30 through a connection to an Internet Service Provider (ISP) or host 35, such as America Online or CompuServe. The set-top box 20 connects to the host 35 through a communications link 37 (e.g., a plain old telephone service (POTS), a digital subscriber line (DSL), or an integrated systems digital network (ISDN)) typically provided by a telecommunications company. Once connected to the host 35, the set-top box 20 can gather web content from any number of content providers 40 connected to the Internet 30. The set-top box 20 also can access web content from a satellite 50. The satellite 50 receives the web content from an uplink 55 provided by a transmitter 57 connected to, for example, the host 35. The web content is provided to the set-top box 20 through a downlink 58 from the satellite 50 to a receiving dish 59. Similarly, the set-top box 20 may receive web content through a cable communications link 60 connected to a cable company 61. Furthermore, web content may be inserted in the vertical blanking interval (VBI) of a TV signal (e.g. broadcast, cable, or satellite). A description of using the VBI to send web content to the settop box 20 is included in U.S. application Ser. No. 09/584,347 filed Jun. 1, 2000, titled “Online/Offline Triggers,” which is incorporated herein by reference in its entirety.

The set-top box 20 may receive TV content from a number of sources. For example, a TV station 70 can broadcast UHF or VHF TV signals 71 from a TV transmitter tower 72. The TV signals 71 are received by an antenna 73 connected to the set-top box 20. Likewise, a TV programming distribution service 80 (e.g., Direct TVTM) can transmit TV content from a transmitter 85 to a satellite 87 for transmission to a receiving dish 59 connected to the set-top box 20. TV content also may be provided directly to the set-top box 20 from the cable company 61 by cable communications link 60.

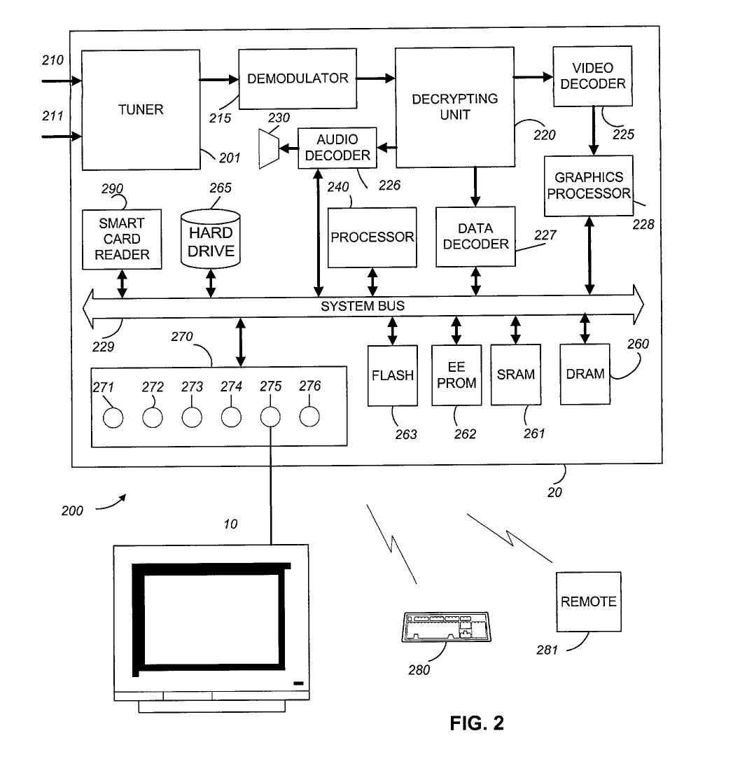

FIG. 2 shows an example of a set-top box system 200 that includes a set-top box 20. The set-top box 20 includes a tuner 201 that may receive quadrature amplitude modulation (QAM), orthogonal frequency division multiplexing (OFDM), and quadrature phase shift key (QPSK) digital TV signals 210. The digital TV signals 210 are received by the tuner 201 from components of a system 100, such as, for example, a cable communications link 61, or a satellite dish 57. Similarly, analog TV signals 211 are provided to the tuner 201 using components of the system 100, such as, for example, antenna 73. The tuner 201 may be implemented using a broadcast in-band tuner, an out-of-band tuner, and a return path tuner. In addition, the TV tuner 201 may receive TV signals 210 or 211 from a video recorder/player device (e.g., a VCR, a DVD player, and a laser disc player). A separate interface also may be provided for receiving these signals (as described in detail below). The tuner 201 isolates a physical channel from the received signal 210 or 211 and converts it to a baseband signal.

The baseband signal output from the tuner 201 is sent to a demodulator 215. The demodulator 215 samples an analog signal and converts it to a digital bit-stream (e.g.,

Moving Pictures Experts Group (MPEG)-2 bit stream). The data may be organized in discrete units that may be referred to as data packets. The bit-stream may include video, audio, and other data. The bit-stream is checked for errors and is forwarded to a decrypting unit 220. The decrypting unit 220 examines the packets in the bit-stream, selects particular packets, decrypts the selected packets, and forwards the decrypted packets to one or more of a video decoder 225, an audio decoder 226, or a data decoder 227.

The video decoder 225 transforms video packets into a sequence of pictures that may be displayed on the display device 10. The output from the video decoder 225 can be sent to an optional graphics processor 228 for enhanced TV and web content display. If a graphics processor is not included, the output of the video decoder 225 is sent directly to the system bus 229. The system bus 229 provides a communications path between the processor 240 and the various components of the set-top box 20. An audio decoder 226 decompresses an audio bit-stream for delivery to a speaker 230 or to the system bus 229. The data decoder 227 is connected to the system bus 229 and decodes data packets for processing by the processor 240.

The processor 240 operates according to any number of available operating systems available from, for example, Power TV, VxWorks, pSOSystem, Microware, Microsoft, Java, or Linux. The processor 240 provides a number of functions for the set-top box 20. For example, the processor 240 initializes the set-top hardware, monitors and manages hardware interrupts, and fetches data and instructions from memory. The processor 240 also processes a range of web and TV content data. Likewise, the processor 240 may execute various programs and applications, for example, a browser, stored in the memory or storage of the set-top box 20.

The set-top box 20 may include a number of memories. For example, a random access memory (RAM) can be used as a temporary storage area for data flowing between the processor 240 and set top hardware. Both dynamic RAM (DRAM) 260 and static RAM (SRAM) 261 may be used. However, the DRAM 260 typically is used for interactive applications while the SRAM 261 may be used to support time sensitive applications, such as MPEG processing. Read only memory (ROM), such as an electrically erasable programming ROM (EEPORM) 262 and a flash memory 263, also may be provided. The EEPROM 262 is used to store control programs and boot-up information for the processor 240. The flash memory 263 may be used to store programs and customer specific information. The flash memory 263 also may be used to store data downloaded from the host 35 that provide, for example, new or additional functionality to the set-top box 20, temporary data or data that are continually updated. The set-top box 20 also may include a large-scale memory device, such as a hard drive 265. The hard drive 265 may be used to store TV and web content, such as, for example, personal documents, favorite Internet sites, email, recorded TV content, data files, audio files, video files, programs, and other data.

The set-top box 20 may include a number of input/output (I/O) interfaces 270 including: a modem 271, a high-speed multimedia interface 272, a serial interface 273, a common interface 274, a TV and VCR interface 275, and wireless interfaces 276 to devices, such as a remote control 280 and a wireless keyboard 281. The set-top box also may include a smart card reader 290. The I/O interfaces provide a communications path between external devices and the system bus 229 to facilitate the exchange of data with the set-top box 20. The set-top box 20 may include one or more of any of these interfaces.

The modem 271 facilitates two-way interactivity between the set-top box 20 and the host 35 or a service provider (e.g., cable company 61). Once activated, the modem 271 can send a request to a web server on the Internet 30, and may enable a viewer to download a file, to send an e-mail message, and to facilitate two-way interactive services, such as home shopping or video-on-demand.

The high-speed multimedia interface 272 allows the set-top box 20 to communicate in real time with other devices, such as a camcorder, a DVD player, a laser disk player, a CD player, and a digital camera. The high-speed interface 272 may be implemented using various hardware devices, such as, for example, an IEEE 1284 parallel port, a universal serial bus, and a 10/100 Base-T (i.e., Ethernet).

The serial interface 273, which may be, for example, an RS-232 interface, provides a serial communications interface that allows the set-top box 20 to exchange data with other devices, such as, for example, a printer, a computer, a personal data assistant (PDA), or an external storage device.

The common interface 274 may be included to provide a standardized interface to connect the set-top box 20 with a separate hardware module, such as a PCMCIA interface.

The TV and VCR interface 275 allows the set-top box 20 to communicate with the display device 10 and a video recorder/player.

Wireless interfaces 276 receive control signals from a user interface device, such as, for example, a wireless keyboard device 280 and a remote control device 281. The control signals are interpreted by processor 240 to activate and control functions of the set-top box 20 and the display device 10. The remote control interface 276 can communicate with the devices 20 using RF signals, infrared signals, or otherwise.

Smart card reader 290 may read a smart card that contains, for example, identification information for authorizing access to the host 35, a service, or an e-commerce transaction.

The set-top box 20 constructs or formats a display for presentation on a screen of the display device 10. The display may be constructed from web content, TV content, or a combination of both web and TV content. A browser (e.g., Liberate's TV navigator) running by the set top processor 240 creates the display from outputs of the memories (e.g., 260, 261, and 262), the hard disk 265, the I/O interfaces 270, and/or the decoders (i.e., 225, 226, and 227). The browser can support a number of computing standards including, for example, hypertext markup language (HTML), JavaScript, and hypertext transfer protocol (HTTP).

The browser integrates web and TV content by processing, for example, a window tag. A widow tag is an HTML-like tag (e.g., <IMG SRC=“TV” x=0 y=0>) that instructs the browser to place TV content received by the set-top box 20 on the screen of the display device 10 at specified coordinates. By modifying a received web page to include a window tag, the browser can display the TV content in conjunction with web content in windows for each type of content. Any number of content windows may be displayed on a screen at one time. In addition, the windows may be separate or may appear to overlap each other. Web content also can be assigned HTML-like tags indicating the arrangement of the web content on the screen. The screen of the display device 10 can be modified to insert user controls, resize the TV image, and provide interactive links by altering instructions of the web content displayed by the browser.

In addition, the set-top box 20 may present content that is overlaid with user interface controls or menus. The controls and menus correspond to functions performed by the set-top box 20, such as, tuning channels. Interactive controls and display windows also may appear as overlaying the TV content or web content on the screen of the display device 10.

Providing content relevant to television programming currently displayed to a viewer, through an intelligent selection, assumes the existence of television programming and available context information. The television programming may be, for example, an episode of a television show. A television show may be broadcast by a particular broadcaster (e.g., network, cable company) during a particular time slot and shown on a particular channel. A television show may be mapped by a host, for example, to a particular category of an EPG. The host may map and/or otherwise classify television programming based on content, television show, episode, broadcaster, channel, time slot, or other criteria.

Context information includes contextual chat rooms, an implementation of which is described in patent application Serial No. 09/475,391, filed December 30, 1999, and titled “Television Chat Rooms.” Context information also includes electronic pages served from servers within an online service provider host complex and/or the Internet. Authors, such as, for example, broadcasters and other interested parties (e.g., business partners, venders, promoters) and/or their agents can create electronic pages using HTML, JavaScript, and/or other markup language. Electronic pages may be published and accessible through online service providers, the World Wide Web, and/or the Internet.

Contextual electronic pages may include episode-specific pages such as, for example, interactive event pages relating to a current episode; an electronic message board to post and read messages about a current episode; electronic viewer polls for soliciting and tallying opinions from viewers; links or pages having episodic tie-ins for retrieving further information about features of an episode; special previews of future episodes; and/or community applications such as chat rooms, interest groups, and instant messaging buddy lists for communicating with other viewers about the current episode. Contextual electronic pages also may include show specific pages such as, for example, an episode guide containing information about past episodes; a cast information page providing information about persons appearing in the show; community applications for discussing past, present and future episodes; and shopping pages for enabling viewers to purchase items featured in the television show, items of a show sponsor, and/or items affiliated with viewer demographics of the television show. In one implementation, contextual shopping pages allow viewers to receive purchasing information about items appearing in a television broadcast by positioning a cursor and/or clicking displayed items. Purchasing information may include price, manufacturer, retailer, in-stock availability, shipping schedule, and/or any other ordering information.

Contextual electronic pages may further include broadcaster-specific pages such as, for example, a complete listing of shows televised by the broadcaster; promotions for interactive events; and/or an electronic portal to websites of business partners and/or advertisers. Additionally, the electronic pages may include content-category-specific pages related to the EPG content category of the television programming and/or the EPG program description.

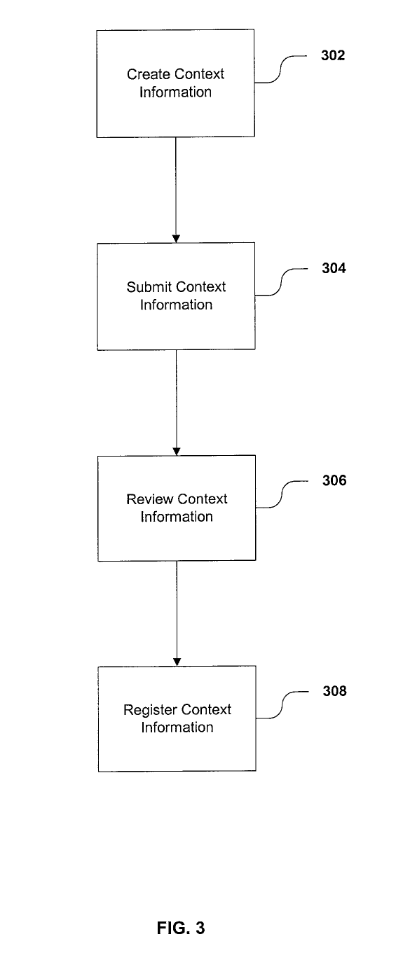

An exemplary process 300 for making context information available to viewers is shown in FIG. 3. In this example, context information includes one or more published electronic pages related to television programming. Initially, context information (e.g., an electronic page) is created (step 302). The host may facilitate creation and/or publication of electronic pages by establishing a predetermined and approved style. The host may, for example, provide a page template to business partners. Electronic pages created with the template may be displayed within a host-branded frame and may contain elements programmed and served by the host, including, but not limited to, HTML links, graphics, promotions and/or advertising. The author of the electronic page may, and is expected to, include additional functionality and programming beyond that provided by the template and/or frame.

In one implementation, the host manages the registration of context information by associating electronic pages with television programming. After creating and optionally publishing the electronic page, the author (e.g., business partner) submits the electronic page to the host for registration (step 304). Prior to registering the electronic page, the host reviews the electronic page (step 306). The review may include examining the electronic page for approved functionality and adherence to style. The electronic page also may be reviewed by an outside agency for appropriateness. The host may refuse to register any page that does not conform to a particular style or that violates the host's publication policy.

After being approved, the context information is then registered (step 308). In one implementation, the host registers content and/or a storage location (e.g., URL) of an electronic page. Registration of published electronic pages may be implemented by associating the electronic page with television programming. In particular, the electronic page may be associated with the name of a particular television show, a certain episode of a television show, a television broadcaster, a content category, a time slot, and/or any other identifier of television programming. In one example, the host enters context information associated with a specific television show into a table assigned for maintaining data related to the specific television show. The data in the table is made available to viewers during the broadcast of the television programming.

Newly registered context information is added and/or assigned to television programming on a regularly scheduled basis. The host may track and report user traffic to registered pages. Such tracking and reporting may be done for customer satisfaction and/or cost analysis. Even after registration, context information may be subjected to viewing policies and may be restricted by filtering settings. Registered pages may be deregistered for violations of the viewing policies or for departure from the style guidelines. Deregistered context information may be removed at any time.

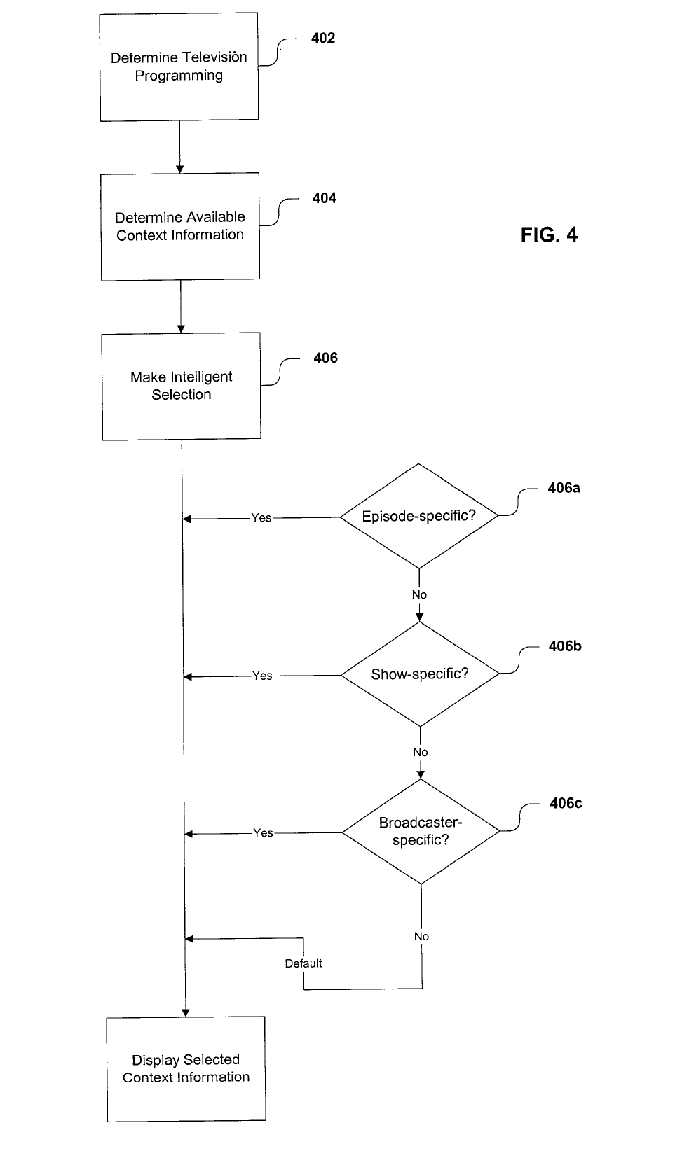

FIG. 4 is a flowchart showing an example of the steps involved in a generalized process 400 for providing content relevant to television programming currently displayed to a viewer. The process 400 may be implemented, for example, by the web-based TV system 100 and/or the set-top box system 200, described above.

In one implementation, the process 400 is initiated by a viewer of a particular television program. To begin the process 400, the viewer may, for example, select a menu option, click a displayed icon or hyperlink, type a particular keyword, and/or push a designated button on a remote control. Upon initiation of the process 400, the television programming being viewed by a viewer at a particular time is determined (step 402). The set-top box and/or host may determine the television programming of a viewer in conjunction with or independently from each other. Implementations of determining the current television programming may include, for example, detecting the channel to which the set-top box is tuned, sampling and/or retrieving embedded information from a television signal corresponding to the television programming, determining the current broadcaster of the television programming, determining the television show and/or episode, and/or determining the EPG category associated with the television programming. Other implementations may involve determining information about the viewer such as, for example, the viewer's local time, gender, age, and interests. In one such possible implementation, the viewer may have previously specified that the News Channel should be presented to that viewer using a “sports context”—e.g., the News Channel content page will emphasize or give priority to news features or headlines that relate to sports.

After having determined the television programming being viewed by the viewer (step 402), context information associated with the television programming available for delivery to the viewer is determined (step 404). The context information can be retrieved whether the set-top box is in an online or offline state, and can come either from local sources (e.g., information previously received and stored in the set-top box) or from remote sources (e.g., host computer or VBI) or a combination of both.

In one implementation, the viewer's set-top box receives and references context information associated with television programming. Referencing the context information associated with television programming may be done in any way that enables searching and retrieval. In one implementation, the viewer's set-top box references the context information according to episode, television show, broadcaster, time slot, and/or content category of the television programming. Relevant information about the television programming can be extracted from the television signal and/or determined from the viewer's EPG.

The set-top box can obtain the context information on-the-fly directly from the host, provided the set-top box is logged into the host at that time. Alternatively, or in addition, the set-top box can retrieve locally stored information, e.g., from the set-top box's internal memory or from storage media such as a cassette tape or CD-ROM loaded into a peripheral device connected to the set-top box. This locally stored information will have been downloaded previously and cached by the set-top box for future use. Retrieval of locally stored information is always available, whether the viewer is offline or online.

Context and/or other information can be communicated to the set-top box for storage and subsequent retrieval using any of several different methods. One available technique is to “trickle-down” information from the host to the set-top box in the background (i.e., transparently to, and without being requested by, the viewer) while the viewer is connected to the host. This trickled-down information then is stored by the set-top box so that it is available for future use, such as, for example, if the viewer, while offline, requests a content page requiring context information.

An alternative mechanism for communicating context or other information to the set-top box involves the use of VBIs (Vertical Blanking Intervals) in TV frames. The standard NTSC TV signal used in the United States is made up of “frames” that are broadcast at a rate of 30 each second. Each frame is formed of 525 scan lines divided equally into two separate and contiguous fields, field 1 and field 2. Each field includes 262.5 scan lines, 241.5 of which carry visible TV signal information—that is, portions of the TV picture.

The first 21 lines in each field represent the VBI. The VBI corresponds to the period of time that it takes the electron beam emitted by the TV set's cathode ray tube (CRT) to reposition itself from the bottom of the TV screen to the top of the screen (also referred to “vertical retracing”). After each field is received and displayed, the electron beam must be repositioned in this manner before drawing of the first scan line of the next field may commence. Accordingly, no visible TV signal information can be transmitted during the VBI, since such visible TV signal information would be lost. Instead, basically any other type of information may be transmitted to the set-top box and used for various purposes, such as, for example, closed captioning, teletext, and electronic program guide information. The amount of data that can be transmitted in this manner is roughly equal to the capacity of a 9600 baud modem for each available scan line in the VBI.

Accordingly, in one implementation, context information can be communicated directly from the TV broadcaster to a set-top box within the VBIs of a TV signal. For each TV field received, the set-top box can extract the context information from the VBI and use it to generate various elements of a content page. The VBI can be used in this regard either in real or near real time (i.e., the context information in the VBI can be extracted and used by the set-top box immediately upon receipt) or the VBI can be used to trickle-down information to the set-top box for storage and subsequent retrieval, as described above.

Other mechanisms for communicating context information to the set-top box include sending data using satellite communications—for example, similar to messages in a pager or Personal Communication Services (PCS) network—and/or an “always connected” technology such as Digital Subscriber Lines (DSL). In either case, the context information received by the set-top box either can be used immediately or stored for subsequent use.

Caching context information and/or other content in the set-top box as described above reduces the demands on the host computer system and on the communication link connecting the host system to the set-top box. For example, viewers need not be logged into the host system in order to be able to view context information. As a result, because viewers can remain logged off the host system for much, if not all, of the viewing session, the number of terminal servers or other connection ports that the host system needs to maintain can be reduced. At the same time, the viewer's telephone line, or other communication medium connecting the viewer to the outside world, need not always be connected to the host system and thus can be freed up for other uses.

Once the available context information is determined (step 404), an intelligent selection from the available context information is made (step 406). In one implementation, an intelligent selecting is made according to a context hierarchy. For example, television programming may include an episode of a television show including certain content and broadcast by a particular broadcaster. According to one context searching hierarchy, first a search is performed for context information associated with the episode (e.g., season finale, particular NFL football game) (step 406a). If episode context information is found, it is selected. If no episode context information is found and/or available, then a search is performed for context information associated with the television show (e.g., name of sitcom, NFL football) (step 406b). If show context information is found, it is selected. If no show context is found and/or available, then a search is performed for context information associated with the broadcaster (e.g., particular network station, cable station) (step 406c). If broadcaster context information is found, it is selected. If no broadcaster context information is found and/or available, default content contextual information (e.g., Networks, Sports) is selected.

According to the above context searching hierarchy, searching for context information associated with a particular broadcaster should only take place if no context information is found to be associated with the episode and television show. Likewise, content channel page context information is used only if no television show or broadcaster context information is found.

In another implementation, an intelligent selection of available context information is performed according to a hierarchy selected by the viewer. In yet another implementation, the hierarchy is selected by the content provider or the broadcaster. In another implementation, the hierarchy is determined based upon user preferences as determined, for example, from information about the viewer such as, for example, the viewer's geographic location, local time, gender, age, and interests. In a further implementation, the hierarchy is not fixed, but rather is dynamic and may be modified at any time.

Finally, the selected context information is delivered to the viewer (step 408). In one implementation, an electronic page associated with the currently viewed television show, episode, broadcaster, timeslot, and/or EPG content category is served to the set-top box of the viewer.

If, for example, the context information served to the set-top box of the viewer is a shopping opportunity related to the episode of the TV show being watched by the viewer, the viewer may decide to purchase the displayed merchandise. To purchase the merchandise, the viewer would designate the merchandise to be purchased using, for example, a wireless keyboard 280 or remote control device 281. The viewer may also provide a credit card number, or, in other approaches, a credit card number may be on file with the host, or the item may be added to the viewer's account with the host, or the viewer may insert a smart card into a smart card reader 290 to facilitate the transaction. Also, the viewer may purchase items related to the TV show by using the wireless keyboard 280 or remote control device 281 to point to the item featured in the TV show and click or otherwise designate the item to be purchased.

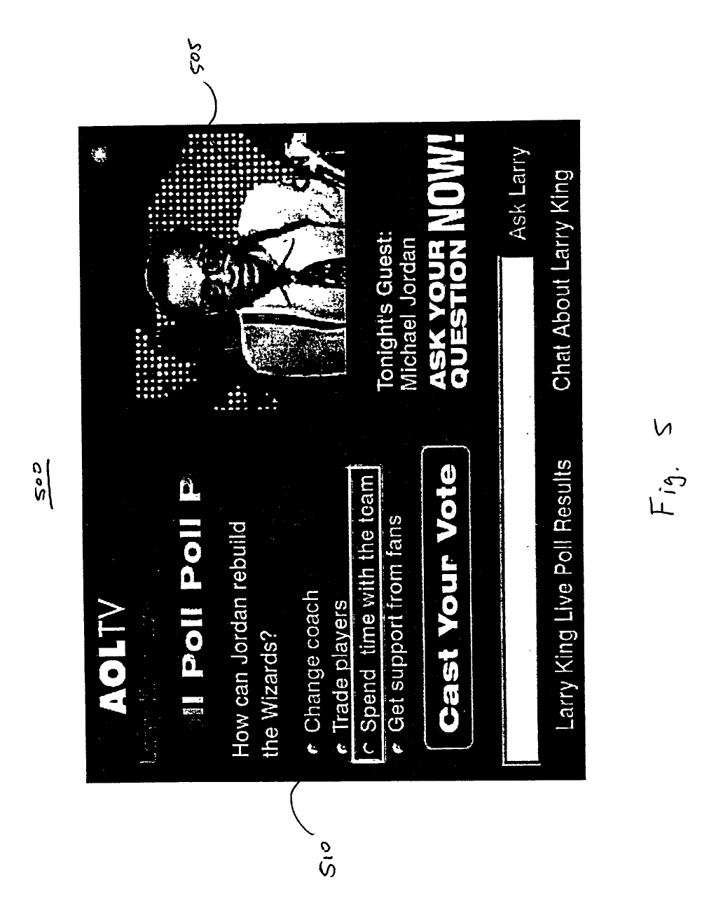

FIG. 5 is one example of an episode-specific page 500 that may be used to present context information to a viewer. The page 500 is an interactive event page includes an area 505 for displaying a television broadcast and an area 510 for displaying context information.

In this example, the context information includes a question box, an electronic ballot for soliciting questions and opinions from viewers, and links to poll results and a chat room.

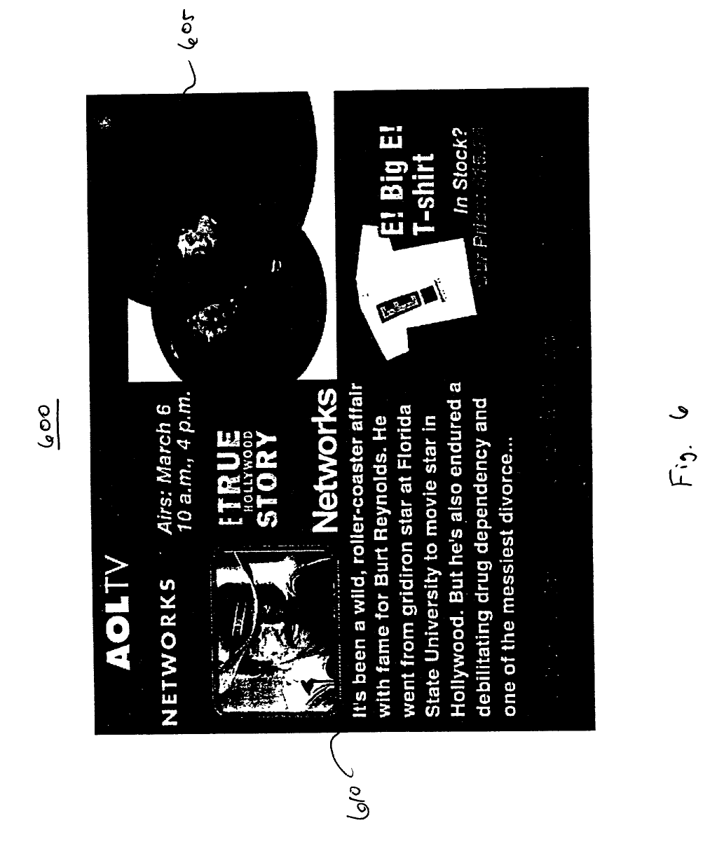

FIG. 6 is on example of a show-specific page 600 that may be used to present context information to a viewer. The page 600 includes an area 605 for displaying a television broadcast and an area 610 for displaying context information. In this example, the contextual information includes further information about a featured television show and a link for ordering merchandise associated with the television show.

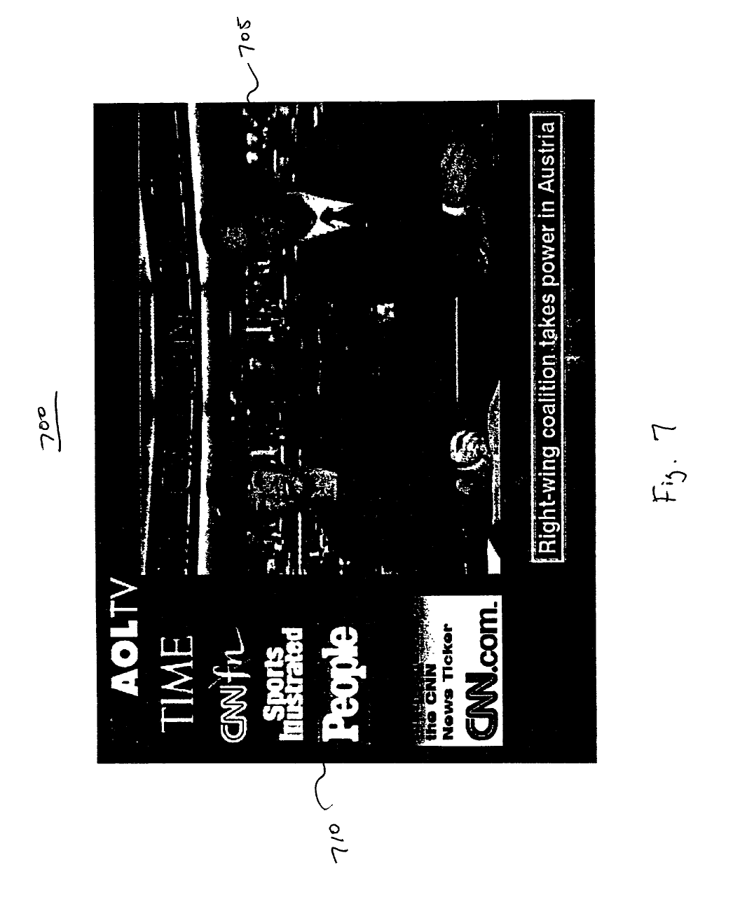

FIG. 7 is on example of a broadcaster-specific page 700 that may be used to present context information to a viewer. The page 700 includes an area 705 for displaying a television broadcast and an area 710 for displaying context information. In this example, the contextual information includes further information about a featured televised news story and links to a broadcaster's optimized home page as well as websites of business partners.

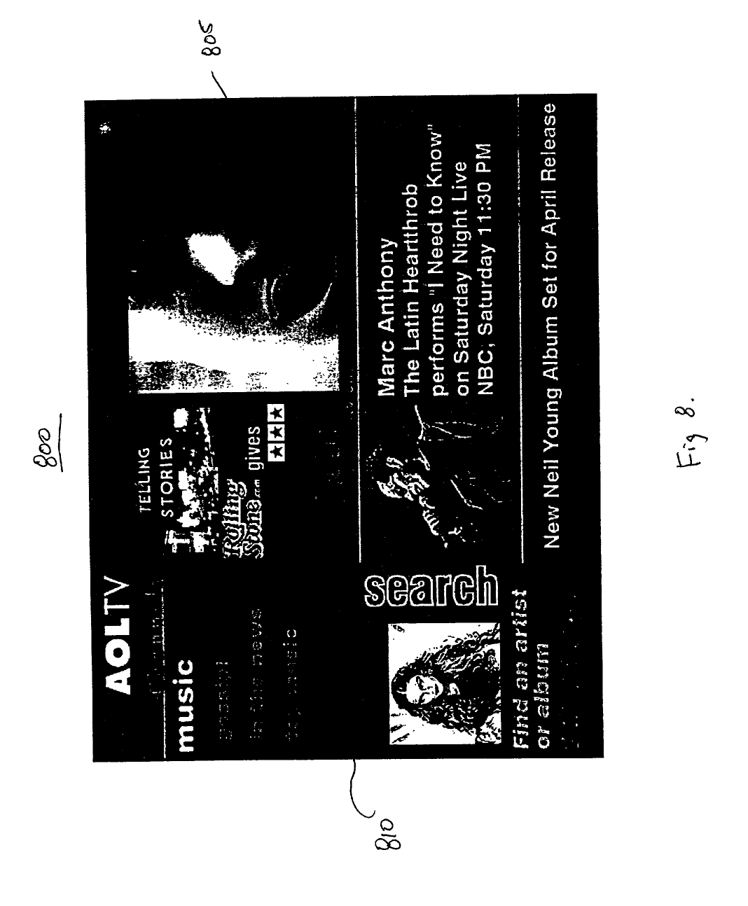

FIG. 8 is on example of a category-specific page 800 that may be used to present context information to a viewer. The page 800 includes an area 805 for displaying a television broadcast and an area 810 for displaying context information. In this example, the contextual information includes links related to category content, i.e., music.

A number of implementations have been described. Nevertheless, it will be understood that various modifications may be made. Accordingly, other embodiments are within the scope of the following claims.

What is claimed is:

1. A method of providing content relevant to television programming, the method comprising:
determining television programming being viewed by a viewer at a particular time;
determining context information associated with the television programming available for delivery to the viewer;
making an intelligent selection from the available context information; and
delivering the selected context information to the viewer.

2. The method of claim 1 wherein determining television programming being viewed comprises determining the television programming tuned to by a set-top box.

3. The method of claim 1 wherein determining television programming being viewed comprises determining the television programming based upon an EPG.

4. The method of claim 1 wherein determining context information associated with the television programming comprises determining context information based upon a television signal received by a set-top box.

5. The method of claim 1 wherein determining context information associated with the television programming comprises determining context information based upon a channel identification number.

6. The method of claim 1 wherein determining context information associated with the television programming comprises determining context information based upon a broadcaster identifier.

7. The method of claim 1 wherein determining context information associated with the television programming comprises determining context information based upon a television show.

8. The method of claim 1 wherein determining context information associated with the television programming comprises determining context information based upon an episode of a television show.

9. The method of claim 1 wherein determining context information associated with the television programming comprises determining context information based upon an EPG identifier.

10. The method of claim 1 wherein determining context information associated with the television programming comprises determining context information based upon a program content category.

11. The method of claim 1 wherein making an intelligent selection comprises selecting context information based upon a predetermined hierarchy.

12. The method of claim 11 wherein the hierarchy is determined by an episode of a television program.

13. The method of claim 11 wherein the hierarchy is determined by a television program.

14. The method of claim 11 wherein the hierarchy is determined by a broadcaster identifier.

15. The method of claim 11 wherein the hierarchy is determined by an EPG identifier.

16. The method of claim 11 wherein the hierarchy comprises:
first selecting context information based upon an episode of a television program;
where no context information based upon an episode is found, selecting context information based upon a television program;
where no context information based upon a television program is found, selecting context information based upon a broadcaster identifier; and
where no context information based upon a broadcaster identifier is found, selecting context information based upon a content category.

17. The method of claim 1 wherein making an intelligent selection comprises selecting context information based upon a viewer selected hierarchy.

18. The method of claim 1 wherein making an intelligent selection comprises selecting context information based upon a dynamically determined hierarchy.

19. The method of claim 1 wherein delivering the selected context information to the viewer comprises displaying the context information by a set-top box.

20. A computer program, stored on a computer readable medium, comprising instructions for causing a computer system to perform the following operations:
determine television programming being viewed by a viewer at a particular time;
determine context information associated with the television programming available for delivery to the viewer;
make an intelligent selection from the available context information; and
deliver the selected context information to the viewer.

21. The computer program of claim 20 wherein the computer readable medium is a disc.

22. The computer program of claim 20 wherein the computer readable medium is a client device.

23. The computer program of claim 20 wherein the computer readable medium is a host device.

24. The computer program of claim 20 wherein the computer readable medium is a propagated signal.
